(19) United States
(12) Patent Application Publication
(10) Pub. No.: US 2026/0307091 A1
(43) Pub. Date: Oct. 8, 2026

(54) Granular Material Spreading Performance Detection System For Agricultural Unmanned Aerial Vehicle And Operation Method Thereof

(71) Applicant: Intelligent Equipment Research Center, Beijing Academy of Agriculture and Forestry Sciences, Beijing (CN)

(72) Inventors: Ruirui ZHANG, Beijing (CN); Chenchen DING, Beijing (CN); Longlong LI, Beijing (CN); Tongchuan YI, Beijing (CN); Xiaoyu CHEN, Beijing (CN); Danzhu ZHANG, Beijing (CN)

(21) Appl. No.: 19/640,688

(22) Filed: Apr. 7, 2026

(30) Foreign Application Priority Data
Apr. 7, 2025 (CN) 202510423628.0

(51) Int. Cl. B05B 12/00; A01C 21/00; B64D 1/16; B64U 101/45

(52) U.S. Cl. CPC B05B 12/004; B64D 1/16; A01C 21/00; B64U 2101/45

(57) ABSTRACT

A granular material spreading performance detection system for an agricultural unmanned aerial vehicle and an operation method of the detection system are provided. The system includes an unmanned aerial vehicle platform, configured to control motion and attitude of an unmanned aerial vehicle; a sampling platform, configured to detect granular material spreading performance of the unmanned aerial vehicle according to the motion and attitude of the unmanned aerial vehicle to obtain granular material spreading performance parameters; a control platform, configured to collect in real time, analyze and display the granular material spreading performance parameters based on detection process control, dynamic wind field modeling, and particle trajectory calculation, and generate a chart and an analysis report for evaluating spreading performance of the agricultural unmanned aerial vehicle.

### CROSS-REFERENCE TO RELATED APPLICATION

This patent application claims the benefit and priority of Chinese Patent Application No. 202510423628.0 filed with the China National Intellectual Property Administration on Apr. 7, 2025, the disclosure of which is incorporated by reference herein in its entirety as part of the present application.

### TECHNICAL FIELD

The present disclosure relates to the technical field of agricultural production and unmanned aerial vehicle control, and in particular, to a granular material spreading performance detection system for an agricultural unmanned aerial vehicle, and an operation method of the granular material spreading performance detection system.

### BACKGROUND

With rapid development of modern agriculture, especially the advancement of precision agriculture technologies, agricultural unmanned aerial vehicles have become important tools in farmland operations, demonstrating significant advantages particularly in the spreading of granular materials such as fertilizers, feed, or seeds. Compared with conventional ground machinery, the agricultural unmanned aerial vehicle features flexible operation, strong terrain adaptability, and minimal crop damage, which greatly improves efficiency and precision of agricultural production. With wide application of the unmanned aerial vehicle in agriculture, the evaluation and detection of the operational performance of the unmanned aerial vehicle have also become critical.

In related technologies, the granular material spreading performance of the agricultural unmanned aerial vehicle is usually detected by manual sampling, which involves complicated and time-consuming operations and is difficult to meet a detection demand of a novel operation mode of the agricultural unmanned aerial vehicle. In addition, the conventional manual layout and sampling method have significant limitations in the detection of spreading particle uniformity and the analysis of spreading effect, lack comprehensive detection of multi-dimensional environmental factors, and cannot perform comprehensive and continuous monitoring of an operation effect within a spreading range of the unmanned aerial vehicle, resulting in low accuracy of fertilization effect detection.

### SUMMARY

The present disclosure provides a granular material spreading performance detection system for an agricultural unmanned aerial vehicle and an operation method of the granular material spreading performance detection system, which are configured to solve defects in the prior art that detecting the granular material spreading performance of the agricultural unmanned aerial vehicle by using a manual sampling mode is complex and time-consuming, the conventional manual layout and sampling method have significant limitations in the detection of spreading particle uniformity and the analysis of spreading effect, and lack comprehensive detection of multi-dimensional environmental factors, resulting in low accuracy of fertilization effect detection, thereby improving efficiency and accuracy of granular material spreading performance detection for the agricultural unmanned aerial vehicle.

The present disclosure provides a granular material spreading performance detection system for an agricultural unmanned aerial vehicle, including:
an unmanned aerial vehicle platform, configured to control motion and attitude of an unmanned aerial vehicle, where the attitude includes a flight height, a heading angle, a pitch angle, and a roll angle;
a sampling platform, configured to detect granular material spreading performance of the unmanned aerial vehicle according to the motion and attitude of the unmanned aerial vehicle to obtain granular material spreading performance parameters, where the granular material spreading performance parameters include particle distribution uniformity, a particle on-target impact force, a particle slot entry angle, particle mass, and micro-environment characteristic parameters of spread granular materials; and
a control platform, where the control platform is configured to control collaborative operation of the unmanned aerial vehicle platform and the sampling platform, the control platform is configured to collect in real time, analyze, and display the granular material spreading performance parameters based on detection process control, dynamic wind field modeling, and particle trajectory calculation, and generate a chart and an analysis report for evaluating spreading performance of the agricultural unmanned aerial vehicle; and
the control platform is further configured to adjust positions and density of sampling points through a sampling layout adaptive optimization mechanism and an environmental factor quantitative modeling mechanism.

According to the granular material spreading performance detection system for an agricultural unmanned aerial vehicle provided by the present disclosure, the unmanned aerial vehicle platform includes:
an unmanned aerial vehicle motion control module, where the unmanned aerial vehicle motion control module is mounted at a middle area of the unmanned aerial vehicle platform, and is configured to control motion and attitude state of the unmanned aerial vehicle; and
a granular material cleaning and recovery module, where the granular material cleaning and recovery module is mounted at the bottom of the unmanned aerial vehicle platform, and is configured to control a telescopic rod and a brush to recover granular materials spread on the ground according to a cleaning instruction, where the cleaning instruction is determined by the control platform based on a size of a test area, a spreading coverage range, and distribution information of remaining granular materials, thereby achieving recovery of all spread granular materials in the test area.

According to the granular material spreading performance detection system for an agricultural unmanned aerial vehicle provided by the present disclosure, the sampling platform includes:
multiple sampling unmanned vehicles, where each sampling unmanned vehicle has Global Navigation Satellite System (GNSS) positioning and LiDAR-assisted perception functions, and collects the granular material spreading performance parameters according to a navigation route;
a networking collaboration module, where the multiple sampling unmanned vehicles are in communication connection with the networking collaboration module separately, and the networking collaboration module is configured to achieve collaborative operation and path obstacle avoidance among the multiple sampling unmanned vehicles by sharing real-time position data and sampling state information of each sampling unmanned vehicle;
a sampling track network, where the sampling track network supports circular, square, and custom-shaped layouts, and is arranged around the sampling platform according to any one of the following sampling layout setting principles:
the sampling points are equidistantly distributed along a radial direction with the unmanned aerial vehicle platform as the center to form an annular or radial track network, where a radius of the annular track and the number of the sampling pints are determined according to a spreading width of the unmanned aerial vehicle and particle distribution variability;
the sampling points are arranged in a uniform grid pattern in a regular plot, and horizontal and vertical spacings are set according to the spreading width and a size of the operation area;
for an irregular plot or a complex terrain, a sampling track is flexibly arranged according to a farmland shape, a topographical variation, and crop growth characteristics; and
meteorological parameters, such as a wind speed, a wind direction, humidity, and a temperature, are monitored in real time during sampling operation, and the density of the sampling points is dynamically adjusted in combination with spreading uniformity data; and
an environment monitoring module, configured to collect meteorological parameters in the operation area of the unmanned aerial vehicle, and detect a spreading trajectory in real time through collaboration of a dynamic wind field model and a particle trajectory calculation model to evaluate an influence of the meteorological parameters on the particle distribution, where the meteorological parameters include a wind speed, a wind direction, humidity, a temperature, and an atmospheric pressure.

According to the granular material spreading performance detection system for an agricultural unmanned aerial vehicle provided by the present disclosure, each sampling unmanned vehicle includes:
a chassis, where the chassis includes a power system, a navigation system, a suspension structure, and an absorber structure;
a granular material particle collection apparatus, where a chute of the granular material particle collection apparatus employs a double-layer structure, and a top layer of the double-layer structure is a reversible V-shaped guide plate;
a granular material spreading performance detection module, including an optical sensor, a piezoelectric sensor, and an angle sensor, where the granular material spreading performance detection module is configured to collect the particle distribution uniformity, the particle mass, and spreading amount; and
a granular material recovery apparatus, mounted at the bottom of the sampling unmanned vehicle, where the granular material recovery apparatus is configured to store a granular material particle sample and has automatic weighing and spectral analysis functions.

According to the granular material spreading performance detection system for an agricultural unmanned aerial vehicle provided by the present disclosure, the control platform includes:
a detection process control module, configured to set and adjust and control in real time various parameters during an entire test process;
an analysis module, configured to calculate granular material spreading performance indicator of the unmanned aerial vehicle according to collected granular material spreading performance parameters and environmental meteorological data, and generate a chart and an analysis report, where the granular material spreading performance indicators include spreading uniformity, granular material distribution, and a coverage rate;
the analysis module includes a dynamic wind field model and a particle trajectory calculation model, and is configured to perform fusion analysis on environment parameters and the granular material spreading performance parameters, where the dynamic wind field model is configured to construct a meteorological scene in an operation area in real time through wind speed, wind direction, humidity, and temperature data, and the particle trajectory calculation model is configured to calculate and predict landing positions of spread particles based on the dynamic wind field model, thereby evaluating an influence of wind field interference on the particle distribution; and
a visualization module, where the visualization module is configured to display the granular material spreading performance parameters, the chart, and the analysis report, and support real-time monitoring and historical data backtracking.

The present disclosure further provides an operation method of a granular material spreading performance detection system for an agricultural unmanned aerial vehicle, where the method is applied to the granular material spreading performance detection system for an agricultural unmanned aerial vehicle, and includes:
detecting, by a sampling platform, granular material spreading performance of an unmanned aerial vehicle according to motion and attitude of the unmanned aerial vehicle to obtain granular material spreading performance parameters, where the granular material spreading performance parameters include particle distribution uniformity, a particle on-target impact force, a particle slot entry angle, particle mass, and micro-environment characteristic parameters of spread granular materials; and
collecting in real time, analyzing, and displaying, by a control platform, the granular material spreading performance parameters based on detection process control, dynamic wind field modeling, and particle trajectory calculation, and generating a chart and an analysis report for evaluating spreading performance of the agricultural unmanned aerial vehicle; and
the control platform further adjusts positions and density of sampling points through a sampling layout adaptive optimization mechanism and an environmental factor quantitative modeling mechanism.

According to the operation method of a granular material spreading performance detection system for an agricultural unmanned aerial vehicle provided by the present disclosure, after generating the chart and the analysis report, the method further includes:
calculating a granular material spreading coefficient of variation and a granular material spreading root mean square error according to the granular material spreading performance parameters, and calculating a granular material spreading operation evaluation result of the unmanned aerial vehicle by using the following formula:

$$F = {W}_{1} C V + {W}_{2} RMSE ;$$

where F is the granular material spreading operation evaluation result of the unmanned aerial vehicle, CV is the granular material spreading coefficient of variation, and RAISE is the granular material spreading root mean square error; W₁ and W₂ are weight coefficients, where a value of each weight coefficient ranges from 0 to 1, and W₁+W₂=1; a value of F ranges from 0 to 1, where 1 denotes the best fertilization effect, and 0 represents the worst fertilization effect.

The present disclosure further provides an operation method of a granular material spreading performance detection system for an agricultural unmanned aerial vehicle provided by the present disclosure, the collecting in real time, analyzing, and displaying, by a control platform, the granular material spreading performance parameters based on detection process control, dynamic wind field modeling, and particle trajectory calculation includes:
establishing a dynamic wind field model in an operation area according to parameters such as a wind speed, a wind direction, humidity, and a temperature collected by an environment monitoring module of the granular material spreading performance detection system for the agricultural unmanned aerial vehicle, thereby simulating wind field variations in different heights and areas;
obtaining parameters such as initial velocity, a release height, and a spreading angle of particles by a granular material spreading performance detection module of the granular material spreading performance detection system for the agricultural unmanned aerial vehicle to provide a basic input for particle trajectory prediction, and calculating air resistance of spread particles when moving in the air, where a magnitude of the air resistance is related to particle shape, velocity, and air density;
predicting a motion trajectory and theoretical landing positions of the particles under a wind-free condition according to the initial velocity, spreading angle, and release height of the particles;
correcting a theoretical trajectory of the spread particles based on data of the wind speed and wind direction provided by the dynamic wind field model, thereby reflecting actual interference of the wind field on the landing positions of the particles, where a magnitude of the wind speed, a wind direction angle, and particle flight time are comprehensively considered during correction;
predicting actual landing positions of the particles in the operation area by combining the theoretical trajectory and a wind field interference correction result;
representing spreading uniformity by a ratio of a standard deviation of particle density to a mean value of the particle density, which is used to reflect distribution uniformity of the spread particles, and determining a spreading coverage rate from a ratio of a particle coverage area to the operation area, which is used to evaluate coverage integrity of a spreading operation; and calibrating a prediction model and correcting related parameters by comparing the predicted landing positions with measured data provided by the sampling platform, and generating a spreading performance detection report, where the report includes the spreading uniformity, the coverage rate, and wind field interference influence information.

The present disclosure further provides an electronic device, including: a memory, a processor, and a computer program that is stored in the memory and that is capable of being run on the processor, where when the processor executes the computer program, the operation method of a granular material spreading performance detection system for an agricultural unmanned aerial vehicle according to any of the foregoing descriptions is implemented.

The present disclosure further provides a non-transitory computer-readable storage medium, where a computer program is stored on the non-transitory computer-readable storage medium, where when the computer program is executed by the processor, the operation method for a granular material spreading performance detection system for an agricultural unmanned aerial vehicle according to any of the foregoing descriptions is implemented.

According to a granular material spreading performance detection system for an agricultural unmanned aerial vehicle and an operation method of the granular material spreading performance detection system provided by the present disclosure, the unmanned aerial vehicle platform is provided to control motion and attitude of the unmanned aerial vehicle, the sampling platform is provided to collect granular material spreading performance parameters, the control platform is provided to generate a fertilization instruction according to the granular material spreading performance parameters to indicate the unmanned aerial vehicle platform to collect in real time, analyze, and display the granular material spreading performance parameters based on detection process control, dynamic wind field modeling, and particle trajectory calculation, and generate a chart and an analysis report, thereby achieving intelligent control of the operation process, and improving efficiency and accuracy of granular material spreading performance detection of the agricultural unmanned aerial vehicle.

### BRIEF DESCRIPTION OF THE DRAWINGS

To describe technical solutions in embodiments of the present disclosure or in the prior art more clearly, the following briefly introduces accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a first diagram of a structure of a granular material spreading performance detection system for an agricultural unmanned aerial vehicle according to the present disclosure;

FIG. 2 is a second diagram of a structure of a granular material spreading performance detection system for an agricultural unmanned aerial vehicle according to the present disclosure;

FIG. 3 is a diagram of four sampling layouts of sampling unmanned vehicles according to the present disclosure;

FIG. 4 is a diagram of a structure of a sampling unmanned vehicle according to the present disclosure;

FIG. 5 is a first flowchart of an operation method of a granular material spreading performance detection system for an agricultural unmanned aerial vehicle according to the present disclosure;

FIG. 6 is a second flowchart of an operation method of a granular material spreading performance detection system for an agricultural unmanned aerial vehicle according to the present disclosure;

FIG. 7 is a diagram of a structure of an electronic device according to the present disclosure.

### REFERENCE NUMERALS

100: unmanned aerial vehicle platform; 110: unmanned aerial vehicle motion control module;
120: granular material cleaning and recovery module; 200: sampling platform; 210: sampling unmanned vehicle;
211: chassis; 212: granular material particle collection apparatus; 213: granular material spreading performance detection module;
214: granular material recovery apparatus; 220: networking collaboration module; 230: sampling track network;
240: environment monitoring module; 300: control platform; 310: detection process control module;
320: analysis module; 330: visualization module

### DETAILED DESCRIPTION OF THE EMBODIMENTS

To make objectives, technical solutions, and advantages of the present disclosure more clearly, the following clearly and completely describes the technical solutions in embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

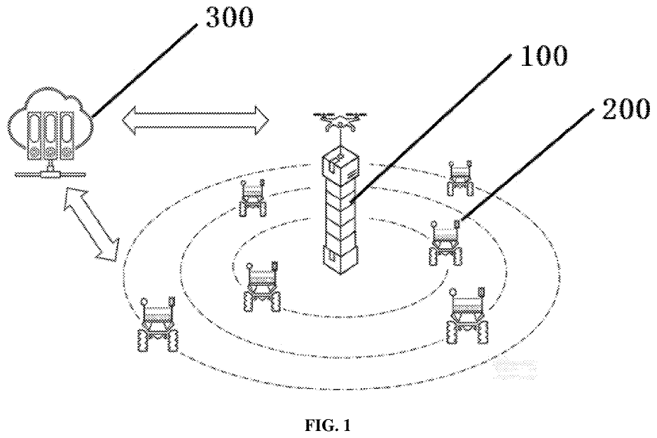

A granular material spreading performance detection system for an agricultural unmanned aerial vehicle and an operation method of the granular material spreading performance detection system are described below with reference to FIG. 1 to FIG. 5.

FIG. 1 is a first diagram of a structure of a granular material spreading performance detection system for an agricultural unmanned aerial vehicle according to the present disclosure. As shown in FIG. 1, the granular material spreading performance detection system for an agricultural unmanned aerial vehicle includes an unmanned aerial vehicle platform 100, a sampling platform 200, and a control platform 300.

The unmanned aerial vehicle platform 100 is configured to control motion and attitude of an unmanned aerial vehicle, where the attitude includes a flight height, a heading angle, a pitch angle, and a roll angle.

In this embodiment, the unmanned aerial vehicle platform 100 can precisely regulate a flight height and attitude of the unmanned aerial vehicle to simulate spreading effect of different models of agricultural unmanned aerial vehicles under various operating conditions.

The sampling platform 200 is configured to detect granular material spreading performance of the unmanned aerial vehicle according to the motion and attitude of the unmanned aerial vehicle to obtain granular material spreading performance parameters, where the granular material spreading performance parameters include, but are not limited to, particle distribution uniformity, a particle on-target impact force, a particle slot entry angle, particle mass, and micro-environment characteristic parameters of spread granular materials.

In this embodiment, the sampling platform 200 includes a particle distribution detection module, a particle on-target impact force and incident angle detection module, a particle mass detection module, and a micro-environment detection module.

In this embodiment, the particle distribution detection module is arranged above a particle collection tank and is configured to collect dynamic changes and distribution situations of particles in the collection tank in real time. Specifically, the particle distribution detection module includes an optical sensor and a high-resolution image sensor. After the particles enter the collection tank, the high-resolution image sensor photographs a distribution image of the particles, the control platform 300 analyzes particle density according to the distribution image through an image processing algorithm to provide data support for evaluation of spreading uniformity and a coverage rate. The optical sensor is configured to measure dynamic changes during a settling process of the granular materials. The optical sensor employs a through-beam optical sensor array. By arranging multiple sensor units, the array forms a cross measurement area, which can accurately capture a motion state of granular material particles in a three-dimensional space.

In this embodiment, the particle on-target impact force and incident angle detection module is mounted on a surface of top layer of the collection tank, and is configured to detect an impact force and an incident angle in real time when the particles impact the collection tank. Specifically, the particle on-target impact force and incident angle detection module includes multiple piezoelectric sensors and angle sensors. When the spread particles impact the collection tank, the piezoelectric sensor detects an impact force, the angle sensor measures an angle that the particles enter a tank body, and feeds back the data to the control platform 300.

In this embodiment, the particle mass detection module is configured to precisely measure the mass of collected spread particles, and the particle mass detection module includes a bottom weighing sensor (for detecting weight of the particles) and a spectrum analysis sensor (for detecting composition of the particles).

The particle mass detection module is disposed at a discharge opening of an inclined slideway. After spread particles fall into the collection tank, a “V”-shaped guide plate at the top layer automatically flips to guide the granular materials to the inclined slideway at a bottom layer, and the slideway at the bottom layer further guides the granular materials to flow to the particle mass detection module. The particle mass detection module can detect the mass and composition of the granular materials collected by each slideway separately.

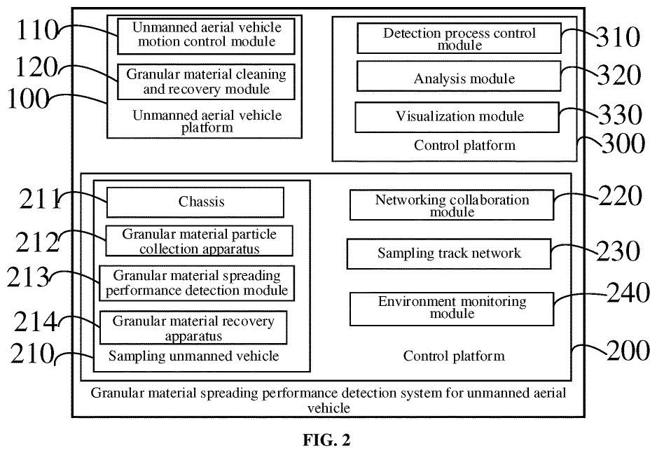

FIG. 2 is a second diagram of a structure of a granular material spreading performance detection system for an agricultural unmanned aerial vehicle according to the present disclosure. In an embodiment shown in FIG. 2, the micro-environment detection module is configured to detect temperature and humidity, wind speed and wind direction, and a spreading scene image in an environment near a sampling unmanned vehicle 210 in real time, thereby providing data for environmental influence analysis of the spreading effect. The micro-environment detection module includes a temperature and humidity sensor, a three-dimensional ultrasonic wind speed and wind direction sensor, and an image sensor. These sensors are mounted at a periphery of a chassis 211 of the unmanned aerial vehicle and cover multiple directions. The micro-environment detection module can analyze the influence of wind on the distribution of the spread granular material by collecting three-dimensional wind speed and wind direction data and combining particle distribution and an on-target angle.

The unmanned aerial vehicle platform 100 and the sampling platform 200 are electrically connected to the control platform 300.

The control platform 300 is configured to control collaborative operation of the unmanned aerial vehicle platform 100 and the sampling platform 200. The control platform is configured to collect in real time, analyze, and display the granular material spreading performance parameters based on detection process control, dynamic wind field modeling, and particle trajectory calculation, and generate a chart and an analysis report for evaluating spreading performance of the agricultural unmanned aerial vehicle.

The control platform can further adjust positions and density of sampling points through a sampling layout adaptive optimization mechanism and an environmental factor quantitative modeling mechanism.

In this embodiment, the control platform 300 is a core control and data processing module of the granular material spreading performance detection system for an agricultural unmanned aerial vehicle, which can achieve automatic management, data analysis, and multi-dimensional correlation analysis during fertilization of the agricultural unmanned aerial vehicle.

In this embodiment, the control platform 300 is configured to set and adjust and control in real time various parameters during the entire test process to ensure collaborative operation of the unmanned aerial vehicle platform 100 and the sampling platform 200 and achieve precise execution of a preset test task.

In this embodiment, the control platform 300 manages the take-off and landing, a flight height and attitude adjustment of the unmanned aerial vehicle through a background system to meet specified requirements of a test scheme. The control platform 300 can dynamically adjust operating parameters of the unmanned aerial vehicle according to real-time environment conditions and a task demand, such as a discharge amount of the spread granular material, thereby ensuring precision and consistency of the operation.

According to a granular material spreading performance detection system for an agricultural unmanned aerial vehicle provided by an embodiment of the present disclosure, the unmanned aerial vehicle platform is provided to control a motion state of the unmanned aerial vehicle, the sampling platform is provided to detect granular material spreading performance of the unmanned aerial vehicle to obtain granular material spreading performance parameters, the control platform is provided to generate a fertilization instruction according to the granular material spreading performance parameters to indicate the unmanned aerial vehicle platform to control the unmanned aerial vehicle to carry out fertilization operation based on a target height and a target attitude. Spreading parameters of the unmanned aerial vehicle can be dynamically adjusted according to collected data, intelligent control of the operation process is achieved, and efficiency and accuracy of granular material spreading performance detection for an agricultural unmanned aerial vehicle can be improved.

In an embodiment shown in FIG. 2, the unmanned aerial vehicle platform 100 includes an unmanned aerial vehicle motion control module 110 and a granular material cleaning and recovery module 120.

The unmanned aerial vehicle motion control module 110 is mounted at a middle area of the unmanned aerial vehicle platform 100, and is configured to control motion and attitude states of the unmanned aerial vehicle.

In this embodiment, the unmanned aerial vehicle motion control module 110 is located at a central position of the unmanned aerial vehicle platform 100 to ensure coverage uniformity and collection uniformity of a test area.

In this embodiment, the unmanned aerial vehicle motion control module 110 includes a telescopic module, an unmanned aerial vehicle fixing stand, and an airframe parameter detection module. The telescopic module is configured to regulate the flight height of the unmanned aerial vehicle; the unmanned aerial vehicle fixing stand is configured to regulate a flight attitude angle of the unmanned aerial vehicle; and the airframe parameter detection module is configured to detect an airframe attitude change, an airframe vibration frequency, a rotor speed, a spreading disc rotational speed, and other airframe parameters of the unmanned aerial vehicle.

In this embodiment, the unmanned aerial vehicle fixing stand is suitable for different models of agricultural unmanned aerial vehicles, the telescopic module and the unmanned aerial vehicle fixing stand can be controlled to adjust an action of the unmanned aerial vehicle in real time according to a preset flight height and a flight attitude angle, thereby simulating spreading situations of the agricultural unmanned aerial vehicle under different operation conditions. In addition, the control platform 300 can collect an airframe attitude, the airframe vibration frequency, the rotor speed, the spreading disc rotational speed, and other data of the unmanned aerial vehicle in real time through the airframe parameter detection module integrated with the stand.

The granular material cleaning and recovery module 120 is mounted at the bottom of the unmanned aerial vehicle platform 100, and configured to control a telescopic rod and a brush to perform a granular material recovery operation according to a cleaning instruction, where the cleaning instruction is determined by the control platform based on a size of a test area, a spreading coverage range, and distribution information of remaining granular materials, thereby achieving recovery of all spread granular materials in the test area.

In this embodiment, the granular material cleaning and recovery module 120 includes the telescopic rod and the brush. After a granular material spreading test of the agricultural unmanned aerial vehicle is finished, the granular material cleaning and recovery module 120 automatically expand a granular material cleaning and recovery apparatus to clean the site, and uses the telescopic rod and a brush apparatus to ensure high efficiency and non-interference of granular material collection. The control platform 300 automatically controls operation and retraction of the brush according to cleaning progress and an area size, thereby achieving automatic granular material recovery.

Specifically, a length of the telescopic rod can be automatically adjusted according to the size of the test area, and a maximum length of the telescopic rod can cover the entire test area. The brush apparatus is made of a soft material with sufficient rigidity, which can effectively clean granular material particles on the ground. During the test, the granular material cleaning and recovery apparatus is in a retracted state, and the brush is tightly attached to a body of the telescopic rod without interfering with the test operation. After the test is finished, the control platform 300 controls the telescopic rod to operate automatically through a control instruction to adjust the telescopic rod to an appropriate length, thereby ensuring coverage of the entire test area during cleaning. The brush on one side of the telescopic rod may automatically pop out from the retracted state by an elastic force when extended, restoring a cleaning function.

In this embodiment, steps of achieving granular material cleaning by the granular material cleaning and recovery apparatus are as follows.
(1) Extending the telescopic rod includes: after receiving the control instruction sent from the control platform 300, gradually extending the telescopic rod from the bottom of the platform until a radius of the test area is reached; and automatically popping out the brush as the telescopic rod extends and enters a cleaning state.
(2) Starting cleaning includes: after the telescopic rod reaches a target length, causing the granular material cleaning and recovery apparatus to perform circumferential motion around the center of the unmanned aerial vehicle platform 100, cleaning, by the brush, the granular material particles on the ground along a circular trajectory to gradually push the dispersed granular material to a designated concentration area.
(3) Recovering granular material includes: after cleaning is completed, concentrating the granular material particles into one area to facilitate a test personnel to recover and process. An automatic cleaning mode reduces granular material waste, improves granular material recovery efficiency, and can prevent the granular material from scattering across the entire test site.

In this embodiment, each unit of the unmanned aerial vehicle motion control module 110 is electrically connected to the control platform 300 and features a highly automated operation mode. The test personnel can control the take-off and landing and attitude adjustment of the tested agricultural unmanned aerial vehicle, as well as start time, a cleaning range, and a cleaning frequency of the cleaning apparatus through the control platform 300, thereby ensuring that the test site is cleaned immediately after each test. In addition, the control platform 300 may further monitor an operating state of each apparatus through the sensor to ensure that no jamming or malfunction occurs in the telescopic rod during the cleaning. If an obstacle is encountered during the cleaning, the system can automatically pause cleaning and feed information back to an operator to alert for troubleshooting, thereby improving safety of the cleaning process and ensuring long-term stable operation of the granular material cleaning and recovery apparatus.

In this embodiment, the control platform 300 supplies power to the tested agricultural unmanned aerial vehicle through the unmanned aerial vehicle motion control module 110, and the test personnel remotely starts or cut off the power supply of the unmanned aerial vehicle through the control platform 300, making the entire test process safer and more controllable.

According to the granular material spreading performance detection system for an agricultural unmanned aerial vehicle provided by an embodiment of the present disclosure, the unmanned aerial vehicle motion control module can control the take-off and landing and attitude adjustment of the agricultural unmanned aerial vehicle, and the test site can be cleaned immediately by the granular material cleaning and recovery module after each test, thereby ensuring cleanliness and efficiency of the test site.

In an embodiment shown in FIG. 2, the sampling platform 200 includes multiple sampling unmanned vehicles 210, a networking collaboration module 200, a sampling track network 230, and an environment monitoring module 240.

Each sampling unmanned vehicle 210 has autonomous navigation capability.

Each sampling unmanned vehicle 210 has GNSS positioning and LiDAR-assisted perception functions, and collects the granular material spreading performance parameters according to a navigation route.

In this embodiment, the navigation route is obtained by comprehensively analyzing and calculating operating parameters of the sampling unmanned aerial vehicle 210, the granular material spreading performance parameters, and meteorological data by the sampling platform 200.

In this embodiment, the sampling unmanned vehicle 210 can operate according to a fixed path, or operate along a sampling trajectory flexibly designed based on an autonomous navigation system, and can dynamically adjust a sampling frequency, a sampling time point, and sampling area distribution. In addition, the granular material particle collection apparatus 212 is automatically opened and closed under the control of the sampling platform 200 to ensure accuracy and consistency of the sampling of the sampling unmanned vehicle 210, thereby optimizing a sampling effect.

In this embodiment, the sampling unmanned aerial vehicle 210 can automatically execute a preset task according to a test task demand, and the control platform 300 dynamically controls each apparatus and adjusts operation parameters of each apparatus during the test according to environmental changes, ensuring smooth test execution and improving system adaptability.

The multiple sampling unmanned aerial vehicles 210 are in communication connection with the networking collaboration module 220 separately, and the networking collaboration module 220 is configured to achieve collaborative operation and path obstacle avoidance among the multiple sampling unmanned vehicles by sharing real-time position data and sampling state information of each sampling unmanned vehicle.

In this embodiment, the networking collaboration module 220 is used for communication networking among the multiple sampling unmanned vehicles 210 and achieving collaborative operation. Through networking, the multiple sampling unmanned vehicles 210 can share real-time position data and state information, thereby ensuring synchronization and coordination during the sampling process.

In this embodiment, the networking collaboration module 220 is connected to the control platform 300. The control platform 300 can achieve global monitoring and command functions through data sent by the networking collaboration module 220. In addition, the operator can utilize the control platform 300 to set a path, a sampling frequency, sampling area allocation, and the like of the sampling unmanned vehicle 210 through the networking collaboration module 220, and monitor an operating state of the sampling unmanned vehicle 210 in real time.

The sampling track network 230 supports circular, square, and custom-shaped layouts, and is arranged around the sampling platform according to any one of the following sampling layout setting principles 1)-4).
1) The sampling points are equidistantly distributed along a radial direction with the unmanned aerial vehicle platform as the center to form an annular or radial track network, where a radius of the annular track and the number of the sampling pints are determined according to a spreading width of the unmanned aerial vehicle and particle distribution variability.
2) The sampling points are arranged in a uniform grid pattern in a regular plot, and horizontal and vertical spacings corresponding to the sampling points are set according to the spreading width and a size of the operation area.
3) For an irregular plot or a complex terrain, a sampling track is flexibly arranged according to a farmland shape, a topographical variation, and crop growth characteristics.
4) Meteorological parameters, such as, a wind speed, a wind direction, humidity, and a temperature, are monitored in real time during sampling operation, and the density of the sampling points is dynamically adjusted in combination with spreading uniformity data.

The environment monitoring module is configured to collect meteorological parameters in the operation area of the unmanned aerial vehicle, and detect a spreading trajectory in real time through collaboration of a dynamic wind field model and a particle trajectory calculation model to evaluate the influence of the meteorological parameters on the particle distribution, where the meteorological parameters include a wind speed, a wind direction, humidity, a temperature, and an atmospheric pressure.

In this embodiment, the sampling track network 230 is configured to generate a moving path of the sampling vehicle in the test area. The sampling track network 230 supports three path implementation modes as follows: (1) fixed path set through an electromagnetic induction wire; (2) flexible path planned through the autonomous navigation system; and (3) fixed path set by mounting a tangible track.

The sampling track network 230 can be designed into a circular, square, or other customized shape to meet different test requirements. The layout of the sampling track network 230 is arranged around the test stand, with the stand as the center, various geometric trajectories can be formed as required to ensure that the entire test area can be covered. This flexible track shape design can achieve multi-angle and multi-position fertilization data collection, thereby enhancing comprehensiveness and diversity of data. In addition, flexible path selection provided by the sampling track network 230 can adapt to different experimental layouts and provide more abundant support for accurate spreading performance test.

The environment monitoring module 240 is configured to collect meteorological parameters in the operation area of the unmanned aerial vehicle, and detect a spreading trajectory in real time through collaboration of a dynamic wind field model and a particle trajectory calculation model to evaluate the influence of the meteorological parameters on particle distribution, where the meteorological parameters include a wind speed, a wind direction, humidity, a temperature, and an atmospheric pressure.

In this embodiment, the environment monitoring module 240 includes multiple meteorological monitoring instruments, which are distributed around the sampling platform 200 and can collect and analyze meteorological data (such as a wind speed, a wind direction, humidity, and a temperature) in the test environment in real time, and these meteorological data directly affect the effect of granular material spreading such as unmanned aerial vehicle fertilization. The control platform 300 compares and analyzes fertilization effects under different meteorological conditions according to the meteorological data. Analysis of key factors, such as the wind speed, the wind direction, and the humidity, can help researchers evaluate distribution situations of the granular materials under different environment conditions, thereby optimizing fertilization amount and uniformity, and ensuring reliability and repeatability of the test result.

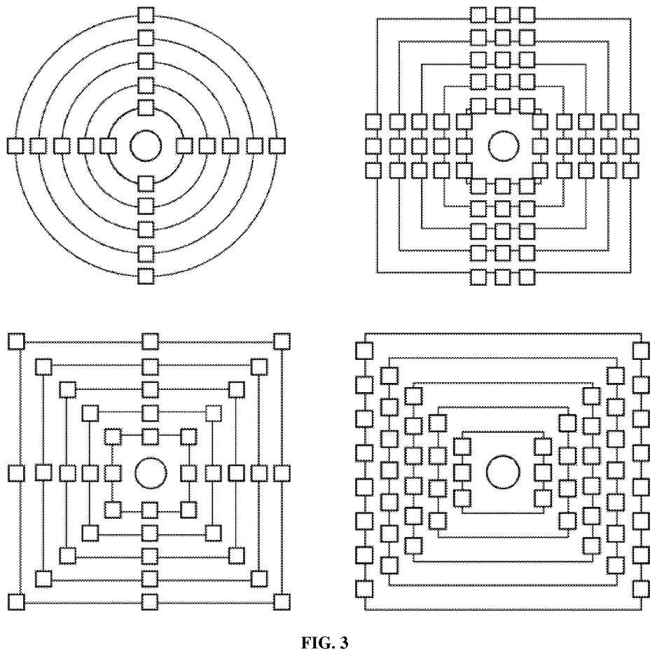

FIG. 3 is a diagram of four sampling layouts of sampling unmanned vehicles according to the present disclosure. According to the embodiment shown in FIG. 3, the multiple sampling unmanned vehicles (marked with black squares in the figure) can be uniformly and symmetrically arranged on the sampling platform and arranged around the unmanned aerial vehicle platform (marked with a black circle in the figure) for rapid and full-coverage collection of the granular material spreading performance parameters of the unmanned aerial vehicle on the unmanned aerial vehicle platform. FIG. 3 includes an annular cross-symmetric sampling platform (upper left). Centered on the unmanned aerial vehicle platform, multiple sampling unmanned vehicles are equidistantly arranged in both the horizontal and vertical directions. FIG. 3 further includes a square cross-symmetric sampling platform (upper right). Centered on the unmanned aerial vehicle platform, three rows and three columns of sampling unmanned vehicles are equidistantly arranged in both the horizontal and vertical directions. FIG. 3 further includes a square sampling platform (lower left) with symmetry characteristics embodied by a shape of Union Jack. Centered on the unmanned aerial vehicle platform, multiple sampling unmanned vehicles are equidistantly arranged in horizontal, vertical, and diagonal directions. FIG. 3 further includes a square symmetric sampling platform (lower right). Centered on the unmanned aerial vehicle platform, multiple sampling unmanned vehicles are arranged in both a left area and a right area of the square.

According to the granular material spreading performance detection system for an agricultural unmanned aerial vehicle provided by an embodiment of the present disclosure, the multiple sampling unmanned vehicles are provided to collect granular material spreading performance parameters to simulate granular material spreading effect under different operation conditions. The networking collaboration module is provided to achieve collaborative operation between the multiple sampling unmanned vehicles. The sampling track network is arranged around the sampling platform to generate multiple geometric paths for the sampling unmanned vehicle for data collection. The environment monitoring module is provided to collect the meteorological data of the environment surrounding the unmanned aerial vehicle, thereby adapting to different test demands. This achieves full coverage of sampling by the sampling unmanned vehicles in the test area, and improves the efficiency and quality of granular material spreading performance parameter collection.

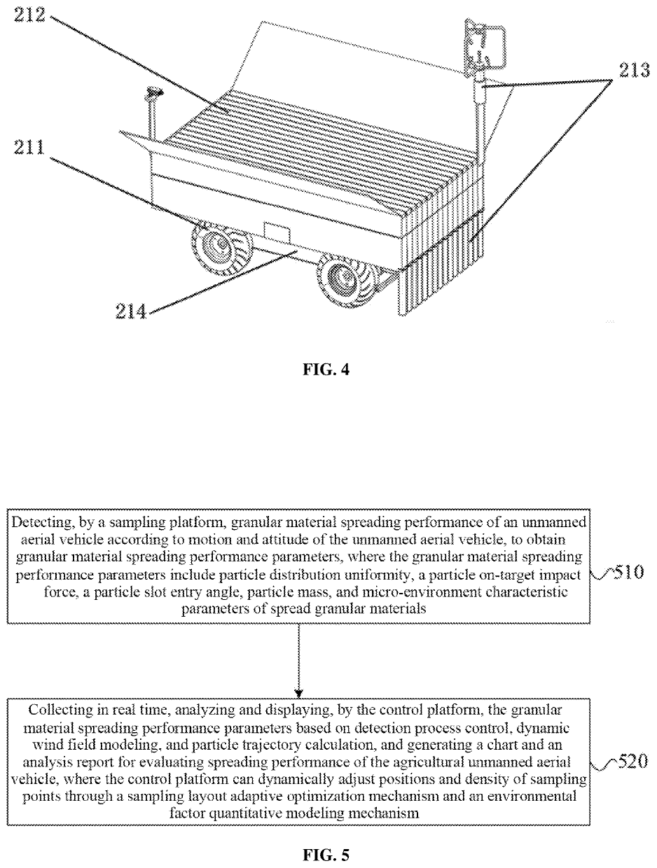

FIG. 4 is a diagram of a structure of a sampling unmanned vehicle according to the present disclosure. In an embodiment shown in FIG. 4, each sampling unmanned vehicle includes a chassis 211, a granular material particle collection apparatus 212, a granular material spreading performance detection module 213, and a granular material recovery apparatus 214.

In this embodiment, the chassis 211 of the sampling unmanned vehicle serves as a core carrier of the whole set of system, which has comprehensive capacities of autonomous navigation, obstacle avoidance, precise positioning, and stable operation, and can ensure efficient execution of a sampling task.

The chassis 211 includes a power system, a navigation system, a suspension structure, and an absorber structure.

In this embodiment, the power system is electrically driven. The navigation system is composed of GNSS, LiDAR, and a vision sensor, and can achieve high-precision positioning and real-time obstacle avoidance through multi-sensor fusion. The chassis 211 is further integrated with multiple sensor modules, which can complete path planning and accurate position control in the sampling area. The suspension structure and the absorber structure can help the sampling unmanned vehicle adapt to a complex terrain and achieve stable driving.

In this embodiment, the chassis 211 of the sampling unmanned vehicle can move autonomously along a preset path or according to a real-time intelligently planned path to ensure smooth completion of the sampling task. In addition, accuracy and safety of the sampling path are guaranteed.

A chute of the granular material particle collection apparatus 212 employs a double-layer structure, and a top layer of the double-layer structure is a reversible V-shaped guide plate.

In this embodiment, the granular material particle collection apparatus 212 is mounted above the chassis 211, and is configured to collect spread granular material particles to facilitate subsequent detection and analysis.

In this embodiment, the granular material particle collection apparatus 212 includes a collection tank and shields.

In this embodiment, the collection tank includes a chute and a tank frame. The chute adopts a double-layer design, including a top layer and a bottom layer. The top layer is composed of a group of neatly arranged, automatically reversible V-shaped guide plates, which guide the granular materials to inclined slideway of the bottom layer during flipping. The slideway at the bottom layer further guides the granular materials to flow toward the tank bottom, ensuring smooth granular material flow. With such a double-layer structure design, the granular materials can be rapidly and smoothly conveyed to a granular material spreading performance parameter detection apparatus to achieve precise detection and data collection.

In this embodiment, the tank frame serves as a main body frame of the collection tank, a shape of which is preferably an equal-size square or rectangle to ensure uniform granular material collection. The shields are disposed on both outer sides of the collection tank and can be automatically opened and closed. Before every granular material collection, the shield is automatically opened to allow the spread particles to enter the collection tank smoothly. After collection is completed, the shield is closed immediately to prevent particles of an external environment from interfering with the collected sample. In addition, the “V”-shaped guide plate in the collection tank has an automatic flipping function, which can be rapidly flipped to clean the collected particles after the collection is completed, thereby ensuring that the next collection is not effected, and preventing the external particles from interfering with the sample. The shield remains closed in a default state to avoid interference from external particles on granular material collection by the collection tank during vehicle travel or standby.

The granular material spreading performance detection module 213 includes an optical sensor, a piezoelectric sensor, and an angle sensor, where the granular material spreading performance detection module is configured to collect particle distribution uniformity, particle mass, and spreading amount.

In this embodiment, the granular material spreading performance detection module 213 includes the aforementioned particle distribution detection module, the aforementioned particle on-target impact force and incident angle detection module, the aforementioned particle mass detection module, and the aforementioned micro-environment detection module, which will not be described in detail in this embodiment.

The granular material recovery apparatus is mounted at the bottom of the sampling unmanned vehicle, where the granular material recovery apparatus is configured to store a granular material particle sample and has functions of automatic weighing and spectral analysis.

In this embodiment, the granular material recovery apparatus 214 has a classified storage function and is equipped with an automatic conveying apparatus or a conveyor belt, so that the detected particles can be automatically guided into storage boxes via the conveying apparatus for classified storage, thereby achieving granular material recovery and subsequent treatment.

According to the granular material spreading performance detection system for an agricultural unmanned aerial vehicle provided by an embodiment of the present disclosure, each sampling unmanned vehicle includes a chassis, which can improve accuracy and safety of a sampling path. The granular material particle collection apparatus is provided to improve data collection efficiency. The granular material spreading performance detection module is provided to achieve comprehensive analysis of multi-dimensional parameters such as particle distribution density, mass, on-target impact force, and environment conditions, thereby evaluating the influence of different spreading conditions on the operation effect. The granular material recovery apparatus is provided to achieve granular material recovery and re-treatment. This reduces labor and time costs, and improves efficiency of granular material spreading performance detection.

In an embodiment shown in FIG. 2, the control platform 300 includes a detection process control module 310, an analysis module 320, and a visualization module 330.

The detection process control module 310 is configured to set and adjust and control in real time various parameters during the entire test process.

In this embodiment, the detection process control module 310 is configured to set and adjust and control in real time various parameters during the entire test process to ensure collaborative operation of the unmanned aerial vehicle platform 100 and the sampling platform 200, thereby precisely executing a preset test task. The detection process control module 310 specifically includes following functions: unmanned aerial vehicle control, sampling platform control and automatic task scheduling.
(1) Unmanned aerial vehicle control includes that: the control platform 300 manages the take-off and landing, a flight height, and attitude adjustment of the unmanned aerial vehicle to meet specified requirements of the test scheme; the detection process control module 310 can dynamically generate a corresponding fertilization instruction according to a real-time environmental condition and a task demand to adjust operating parameters of the unmanned aerial vehicle, such as a discharge amount of the spread granular material, thereby ensuring precision and consistency of the operation.
(2) Sampling platform 200 control includes that: the detection process control module 310 controls a moving path of an autonomous sampling vehicle, which may be set as a fixed path or a sampling trajectory flexibly designed by the autonomous navigation system, and the detection process control module 310 can dynamically adjust a sampling frequency, a sampling time point, and sampling area distribution; in addition, under the control of this module, the granular material collection apparatus of the sampling platform 200 can be opened and closed automatically to ensure accuracy and consistency of sampling and optimize the sampling effect.
(3) Automatic task scheduling includes that: the detection process control module 310 can automatically execute the preset task according to the test task demand, and dynamically adjust operating parameters of each device according to environment changes during the test, thereby ensuring smooth proceeding of the test and improving adaptability of the granular material spreading performance detection system for an agricultural unmanned aerial vehicle.

The analysis module 320 is configured to calculate granular material spreading performance indicators of the unmanned aerial vehicle according to the collected granular material spreading performance parameters and environmental meteorological data, and generate a chart and an analysis report. The granular material spreading performance parameter indicators include spreading uniformity, granular material distribution, and a coverage rate. The analysis module 320 includes a dynamic wind field model and a particle trajectory calculation model, and is configured to perform fusion analysis of environmental parameters and the granular material spreading performance parameters, where the dynamic wind field model is configured to construct a meteorological scene in the operation area in real time through the wind speed, wind direction, humidity, and temperature data, and the particle trajectory calculation module is configured to calculate and predict landing positions of spread particles based on the dynamic wind field model, thereby evaluating the influence of wind field interference on particle distribution.

In this embodiment, the analysis module 320 is configured to receive, process, and analyze data from the unmanned aerial vehicle and the sampling platform 200 in real time to ensure accuracy, comprehensiveness, and multidimensionality of the data, thereby providing a scientific basis for subsequent analysis. The analysis module 320 specifically includes the following functions: real-time data collection, data analysis and feedback and intelligent feedback function.
(1) Real-time data collection includes that: the analysis module 320 is configured to collect various parameters, such as fertilization uniformity, particle mass, and a spreading area coverage rate, through a communication network with the unmanned aerial vehicle, the sampling platform 200, and an operation station, and transmit these data to the control platform 300 in real time.
(2) Data analysis and feedback includes that: the analysis module 320 is configured to perform deep analysis on collected origin data, such as evaluating the spreading uniformity, the granular material distribution, and the coverage rate, and generate a chart and an analysis report based on a result for reference by the test personnel.

In this embodiment, the granular material spreading performance indicators of the unmanned aerial vehicle include a granular material spreading coefficient of variation (CV), and a granular material spreading root mean square error (RMSE), and a calculation formula for a corresponding granular material spreading operating evaluation effect F of the agricultural unmanned aerial vehicle is shown as follows:

$$F = {W}_{1} C V + {W}_{2} RMSE ;$$

where W₁ and W₂ are weight coefficients (a value of each weight coefficient ranges from 0 to 1, and W₁+W₂=1), a value of F ranges from 0 to 1, where 1 denotes the best fertilization effect, and 0 represents the worst fertilization effect.

For example, during fertilization test of the agricultural unmanned aerial vehicle, it can be set that W₁=W₂=0.5, and a formula for fertilization operation effect evaluation is as follows:

$$F = 0.5 \frac{CV}{{CV}_{max}} + 0.5 \frac{R M S E}{R M S {E}_{max}} ;$$

where CVₘₐₓ is a maximum value of CV, RMSEₘₐₓ is a maximum value of RMSE, when both CV and RMSE are close to their respective maximum values, the F value approaches 1, indicating the best fertilization performance; and when both CV and RMSE are close to 0, the F value approaches 0, indicating the worst fertilization effect.

In this embodiment, the granular material spreading coefficient of variation is an indicator for measuring a relative dispersion degree of data. The sampling unmanned vehicle 210 collects mass data of the granular material particle at different sampling points, and calculates the granular material spreading coefficient of variation CV by combining the coefficient of variation, which is specifically expressed by the following formula:

$$C V = ( \frac{σ}{μ} ) \times 100 \% ;$$

where σ is a sample standard deviation, and p is a sample mean. In this embodiment, coefficients of variation of different sampling points are calculated to indicate granular material spreading uniformity, the lower the CV value, the smaller the dispersion degree of the data, the better the fertilization uniformity.

In this embodiment, the granular material spreading root mean square error RMSE is used for evaluating a deviation between actual fertilization amount and target set fertilization amount at a specific position tested by the platform, which reflects an average level of a prediction error. The granular material spreading RMSE is calculated in combination with the root mean square error, as expressed by the following formula:

$$RMSE = \sqrt{\frac{1}{n} {\sum }_{i = 1}^{n} {( {y}_{i} - {\hat{y}}_{i} )}^{2}} ;$$

where yᵢ is an i-th observation value (actual value), ŷᵢ is an i-th prediction value (target value), n is the number of samples, the smaller the RMSE, the closer the prediction value to the actual value, and the higher the accuracy of the model or method. That is, the lower the RMSE, the better the fertilization uniformity.
(3) The analysis module 320 further features an intelligent feedback function, which can dynamically adjust operating parameters of the system based on an analysis result to optimize spreading effect and sampling accuracy.

The visualization module 330 is configured to display at least one of the granular material spreading performance indicator, the chart, and the analysis report.

In this embodiment, the visualization module 330 is configured to display the analyzed data from the data processing module on a user interface in a visualization form, so that a user can intuitively view the test result, such as fertilization uniformity and particle distribution, which facilitates the long-term storage and management of data and provides data support for subsequent analysis and trend comparison.

According to the granular material spreading performance detection system for an agricultural unmanned aerial vehicle provided by an embodiment of the present disclosure, the detection process control module is provided to improve precision and consistency of the fertilization operation of the unmanned aerial vehicle. The analysis module is provided to receive, process, and analyze various data from the unmanned aerial vehicle and the sampling platform in real time, thereby improving accuracy, comprehensiveness, and multidimensionality of the data. The visualization module is provided to display the analyzed data on the user interface in a visualization form to help the user intuitively view the test result, thereby providing long-term storage and management of data to provide data support for subsequent analysis and trend comparison.

The following describes an operation method of the granular material spreading performance detection system for an agricultural unmanned aerial vehicle provided by the present disclosure. The operation method of the granular material spreading performance detection system for an agricultural unmanned aerial vehicle described below and the granular material spreading performance detection system for an agricultural unmanned aerial vehicle described above may be mutually referenced correspondingly.

FIG. 5 is a first flowchart of an operation method of a granular material spreading performance detection system for an agricultural unmanned aerial vehicle according to the present disclosure. As shown in FIG. 5, the method includes steps 510 and 520.

In step 510, granular material spreading performance of an unmanned aerial vehicle is detected by a sampling platform according to motion and attitude of the unmanned aerial vehicle, to obtain granular material spreading performance parameters, where the granular material spreading performance parameters include particle distribution uniformity, a particle on-target impact force, a particle slot entry angle, particle mass, and micro-environment characteristic parameters of spread granular materials.

In step 510, the sampling platform 200 includes a particle distribution detection module, a particle on-target impact force and incident angle detection module, a particle mass detection module, and a micro-environment detection module.

In this embodiment, the particle distribution detection module is arranged above a particle collection tank and is configured to collect dynamic changes and distribution situations of particles in the collection tank in real time. Specifically, the particle distribution detection module includes an optical sensor and a high-resolution image sensor. After the particles enter the collection tank, the high-resolution image sensor photographs a distribution image of the particles, the control platform analyzes particle density according to the distribution image through an image processing algorithm to provide data support for evaluation of spreading uniformity and a coverage rate. The optical sensor is configured to measure dynamic changes during a settling process of the granular materials. The optical sensor employs a through-beam optical sensor array. By arranging multiple sensor units, the array forms a cross measurement area, which can accurately capture a motion state of granular material particles in a three-dimensional space.

In this embodiment, the particle on-target impact force and incident angle detection module is mounted on a surface of a top layer of the collection tank, and is configured to detect an impact force and an incident angle in real time when the particles impact the collection tank. Specifically, the particle on-target impact force and incident angle detection module includes multiple piezoelectric sensors and angle sensors. When the spread particles impact the collection tank, the piezoelectric sensor detects an impact force, the angle sensor measures an angle that the particles enter a tank body, and feeds back the data to the control platform.

In this embodiment, the particle mass detection module is configured to precisely measure the mass of the collected spread particles, includes a bottom weighing sensor (for detecting weight of the particles) and a spectrum analysis sensor (for detecting composition of the particles).

The particle mass detection module is disposed at a discharge opening of an inclined slideway. After spread particles fall into the collection tank, a “V”-shaped guide plate at the top layer automatically flips to guide the granular materials to the inclined slideway at a bottom layer, and the slideway at the bottom layer further guides the granular material to flow to the particle mass detection module. The particle mass detection module can detect the mass and composition of the granular materials collected by each slideway separately.

In this embodiment, the micro-environment detection module is configured to detect temperature and humidity, wind speed and wind direction, and a spreading scene image in an environment near a sampling unmanned vehicle, thereby providing data for environmental influence analysis of the spreading effect. The micro-environment detection module includes a temperature and humidity sensor, a three-dimensional ultrasonic wind speed and wind direction sensor, and an image sensor. These sensors are mounted at a periphery of a chassis of the unmanned aerial vehicle and cover multiple directions. The micro-environment detection module can analyze the influence of wind on the distribution of the spread granular material by collecting three-dimensional wind speed and wind direction data and combining particle distribution and an on-target angle.

In step 520, the granular material spreading performance parameters are collected in real time, analyzed and displayed by the control platform based on detection process control, dynamic wind field modeling, and particle trajectory calculation, and a chart and an analysis report are generated for evaluating spreading performance of the agricultural unmanned aerial vehicle. The control platform can further adjust positions and density of sampling points through a sampling layout adaptive optimization mechanism and an environmental factor quantitative modeling mechanism.

In step 520, the motion state of the unmanned aerial vehicle (including the agricultural unmanned aerial vehicle) includes an ascending height and a descending height of the unmanned aerial vehicle, as well as an attitude. For example, the motion state of the unmanned aerial vehicle includes a flight speed, a heading angle, a pitch angle, a roll angle, and the like of the unmanned aerial vehicle.

In this embodiment, the unmanned aerial vehicle platform can precisely regulate the flight height and the attitude of the unmanned aerial vehicle to simulate spreading effect of different models of agricultural unmanned aerial vehicles under various operating conditions.

In this embodiment, the control platform is a core control and data processing module of the granular material spreading performance detection system for an agricultural unmanned aerial vehicle, which can achieve automatic management, data analysis, and multi-dimensional correlation analysis during fertilization of the agricultural unmanned aerial vehicle.

In this embodiment, the control platform is configured to set and adjust and control in real time, various parameters during the entire test process to ensure collaborative operation of the unmanned aerial vehicle platform and the sampling platform and precise execution of a preset test task.

In this embodiment, the control platform manages the take-off and landing, a flight height and attitude adjustment of the unmanned aerial vehicle through a background system to meet specified requirements of a test scheme. The control platform can dynamically adjust operating parameters of the unmanned aerial vehicle according to real-time environment conditions and a task demand, such as a discharge amount of the spread granular material, thereby ensuring precision and consistency of the operation.

According to an operation method for the granular material spreading performance detection system for an agricultural unmanned aerial vehicle provided by an embodiment of the present disclosure, the unmanned aerial vehicle platform is provided to control the motion state of the unmanned aerial vehicle. The sampling platform is provided to detect granular material spreading performance of the unmanned aerial vehicle to obtain granular material spreading performance parameters. The control platform is provided to generate a fertilization instruction according to the granular material spreading performance parameters to indicate the unmanned aerial vehicle platform to control the unmanned aerial vehicle to perform fertilization operation based on a target height and a target attitude, so that spreading parameters of the unmanned aerial vehicle can be dynamically adjusted according to collected data, intelligent control of the operation process is achieved, and granular material spreading performance detection efficiency and accuracy of an agricultural unmanned aerial vehicle can be improved.

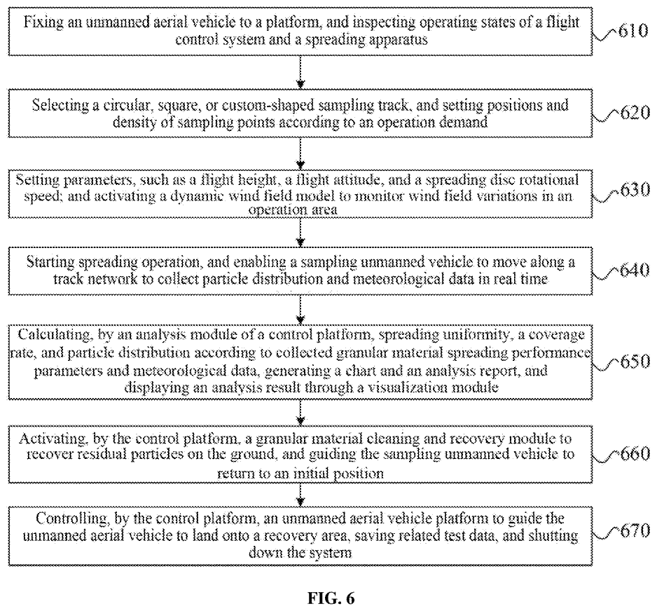

FIG. 6 is a second flowchart of an operation method for a granular material spreading performance detection system for an agricultural unmanned aerial vehicle. In an embodiment shown in FIG. 6, the operation method for a granular material spreading performance detection system for an agricultural unmanned aerial vehicle includes steps 610-670.

In step 610, an unmanned aerial vehicle is fixed to a platform, and operating states of a flight control system and a spreading apparatus are inspected.

In step 620, a circular, square, or custom-shaped sampling track is selected, and positions and density of sampling points are set according to an operation demand.

In step 630, parameters, such as a flight height, a flight attitude, and a spreading disc rotational speed, are set; and a dynamic wind field model is activated to monitor wind field variations in an operation area.

In step 640, spreading operation is started, and a sampling unmanned vehicle is enabled to move along a track network to collect particle distribution and meteorological data in real time.

In step 650, spreading uniformity, a coverage rate, and particle distribution are calculated by an analysis module of a control platform according to collected granular material spreading performance parameters and meteorological data, a chart and an analysis report are generated, and an analysis result is displayed through a visualization module.

In step 660, a granular material cleaning and recovery module is activated by the control platform to recover residual particles on the ground, and the sampling unmanned vehicle is guided to return to an initial position.

In step 670, an unmanned aerial vehicle platform is controlled by the control platform to guide the unmanned aerial vehicle to land onto a recovery area, related test data is saved, and the system is shut down.

In some embodiments, the granular material cleaning and recovery module is mounted at the bottom of the unmanned aerial vehicle platform, and after a fertilization instruction is generated according to the granular material spreading performance parameters, the method further includes that: the granular material cleaning and recovery module controls a telescopic rod and a brush to perform granular material recovery operation according to a cleaning instruction, where the cleaning instruction is determined by the control platform based on a size of an area to be cleaned and cleaning progress.

In this embodiment, the granular material cleaning and recovery module includes a telescopic rod and a brush. After a granular material spreading test of the agricultural unmanned aerial vehicle is finished, the granular material cleaning and recovery module automatically expands a granular material cleaning and recovery apparatus to clean the site, and uses the telescopic rod and a brush apparatus to ensure high efficiency and non-interference of granular material collection. The control platform automatically controls operation and retraction of the brush according to cleaning progress and an area size, thereby achieving automatic granular material recovery.

Specifically, a length of the telescopic rod can be automatically adjusted according to the size of the test area, and a maximum length of the telescopic rod can cover the entire test area. The brush apparatus is made of a soft material with sufficient rigidity, which can effectively clean granular material particles on the ground. During the test, the granular material cleaning and recovery apparatus is in a retracted state, and the brush is tightly attached to a body of the telescopic rod without interfering with the test operation. After the test is finished, the control platform controls the telescopic rod to operate automatically through a control instruction to adjust the telescopic rod to an appropriate length, thereby ensuring coverage of the entire test area during cleaning. The brush on one side of the telescopic rod may automatically pop out from the retracted state by an elastic force when extended, restoring a cleaning function.

In this embodiment, steps of achieving granular material cleaning by the granular material cleaning and recovery apparatus are as follows.
(1) Extending the telescopic rod includes: after receiving the control instruction sent from the control platform 300, gradually extending the telescopic rod from the bottom of the platform until a radius of the test area is reached; and automatically popping out the brush as the telescopic rod extends and enters a cleaning state.
(2) Starting cleaning includes: after the telescopic rod reaches a target length, causing the granular material cleaning and recovery apparatus to perform circumferential motion around the center of the unmanned aerial vehicle platform, cleaning, by the brush, the granular material particles on the ground along a circular trajectory to gradually push the dispersed granular material to a designated concentration area.
(3) Recovering granular material includes: after cleaning is completed, concentrating the granular material particles into one area to facilitate a test personnel to recover and process. An automatic cleaning mode reduces granular material waste, improves granular material recovery efficiency, and can prevent the granular material from scattering across the entire test site.

In this embodiment, each unit of the unmanned aerial vehicle motion control module is electrically connected to the control platform and features a highly automated operation mode. The test personnel can control the take-off and landing and attitude adjustment of the tested agricultural unmanned aerial vehicle, as well as start time, a cleaning range, and a cleaning frequency of the cleaning apparatus through the control platform, thereby ensuring that the test site is cleaned immediately after each test. In addition, the control platform may further monitor an operating state of each apparatus through the sensor to ensure that no jamming or malfunction occurs in the telescopic rod during the cleaning. If an obstacle is encountered during the cleaning, the system can automatically pause cleaning and feed information back to an operator to alert for troubleshooting, thereby improving safety of the cleaning process and ensuring long-term stable operation of the granular material cleaning and recovery apparatus.

In this embodiment, the control platform supplies power to the tested agricultural unmanned aerial vehicle through the unmanned aerial vehicle motion control module, and the test personnel remotely starts or cut off the power supply of the unmanned aerial vehicle through the control platform, making the entire test process safer and more controllable.

According to the operation method for the granular material spreading performance detection system for an agricultural unmanned aerial vehicle provided by an embodiment of the present disclosure, the test site can be cleaned immediately by the granular material cleaning and recovery module after each test, thereby ensuring cleanliness and efficiency of the test site.

In some embodiments, the control platform includes an analysis module and a visualization module. After a fertilization instruction is generated according to the granular material spreading performance parameters, the method further includes that: the analysis module calculates granular material spreading performance indicators of the unmanned aerial vehicle according to the granular material spreading performance parameters and the meteorological data in a surrounding environment of the unmanned aerial vehicle, and generates a chart and an analysis report according to the granular material spreading performance indicators, where the granular material spreading performance indicators include at least one of spreading uniformity, granular material distribution, and a coverage rate; and the visualization module displays at least one of the granular material spreading performance indicator, the chart, and the analysis report.

In this embodiment, the analysis module is configured to receive, process, and analyze various data from the unmanned aerial vehicle and the sampling platform in real time to ensure accuracy, comprehensiveness, and multidimensionality of the data, thereby providing a scientific basis for subsequent analysis. The analysis module specifically includes the following functions: real-time data collection, data analysis and feedback and intelligent feedback function.
(1) Real-time data collection includes that: the analysis module is configured to collect various parameters such as fertilization uniformity, particle mass, and a spreading area coverage rate through a communication network with the unmanned aerial vehicle, the sampling platform, and an operation station, and transmit these data to the control platform in real time.
(2) Data analysis and feedback includes that: the analysis module is configured to perform deep analysis on collected origin data, such as evaluating the spreading uniformity, the granular material distribution, and the coverage rate, and generate a chart and an analysis report based on a result for reference by the test personnel.

In this embodiment, after the chart and the analysis report is generated, the method further includes:
obtaining a granular material spreading coefficient of variation CV, and a granular material spreading root mean square error RMSE, where a following formula is used for calculating a granular material spreading operating evaluation result of the agricultural unmanned aerial vehicle:

$$F = {W}_{1} C V + {W}_{2} RMSE ;$$

where W₁ and W₂ are weight coefficients, where a value of each weight coefficient ranges from 0 to 1, and W₁+W₂=1; and a value of F ranges from 0 to 1, where 1 denotes the best fertilization effect, and 0 represents the worst fertilization effect.

In this embodiment, the granular material spreading performance indicators of the unmanned aerial vehicle include the granular material spreading coefficient of variation (CV) and the granular material spreading root mean square error (RMSE), and a calculation formula for a corresponding granular material spreading operating evaluation effect F of an agricultural unmanned aerial vehicle is shown as above.

For example, during fertilization test of the agricultural unmanned aerial vehicle, it can be set that W₁=W₂=0.5, and a formula for fertilization operation effect evaluation is as follows:

$$F = 0. 5 \frac{CV}{{CV}_{max}} + 0.5 \frac{R M S E}{R M S {E}_{max}} ;$$

where CVₘₐₓ is a maximum value of CV, RMSEₘₐₓ is a maximum value of RMSE, when both CV and RMSE are close to their respective maximum values, the F value approaches 1, indicating the best fertilization performance; and when both CV and RMSE are close to 0, the F value approaches 0, indicating the poorest fertilization effect.

In this embodiment, the granular material spreading coefficient of variation is an indicator for measuring a relative dispersion degree of data. The sampling unmanned vehicle collects mass data of the granular material particles at different sampling points, and calculates the granular material spreading coefficient of variation CV by combining the coefficient of variation, which is specifically expressed by the following formula:

$$CV = ( \frac{σ}{μ} ) \times 100 \% ;$$

where σ is a sample standard deviation, and p is a sample mean. Coefficients of variation of different sampling points are calculated to indicate granular material spreading uniformity, the lower the CV value, the smaller the dispersion degree of the data, the better the fertilization uniformity.

In this embodiment, the granular material spreading root mean square error RMSE is used for evaluating a deviation between actual fertilization amount and target set fertilization amount at a specific position tested by the platform, which reflects an average level of a prediction error. The granular material spreading RMSE is calculated in combination with the root mean square error, as expressed by the following formula:

$$RMSE = \sqrt{\frac{1}{n} {\sum }_{i = 1}^{n} {( {y}_{i} - {\hat{y}}_{i} )}^{2}} ;$$

where yᵢ is an i-th observation value (actual value), ŷᵢ is an i-th prediction value (target value), n is the number of samples, the smaller the RMSE, the closer the prediction value to the actual value, and the higher the accuracy of the model or method. That is, the lower the value of the RMSE, the better the fertilization uniformity.
(3) The analysis module further features an intelligent feedback function, which can dynamically adjust operating parameters of the granular material spreading performance detection system based on an analysis result to optimize spreading effect and sampling accuracy.

In this embodiment, the visualization module is configured to display the analyzed data from the data processing module on a user interface in a visualization form, so that a user can intuitively view the test result, such as fertilization uniformity and particle distribution, which facilitates the long-term storage and management of data and provides data support for subsequent analysis and trend comparison.

According to the operation method for the granular material spreading performance detection system for an agricultural unmanned aerial vehicle provided by an embodiment of the present disclosure, the detection process control module is provided to improve precision and consistency of the fertilization operation of the unmanned aerial vehicle. The analysis module is provided to receive, process, and analyze various data from the unmanned aerial vehicle and the sampling platform in real time, thereby improving accuracy, comprehensiveness, and multidimensionality of the data. The visualization module is provided to display the analyzed data on the user interface in a visualization form to help the user intuitively view the test result, thereby providing long-term storage and management of data to provide data support for subsequent analysis and trend comparison.

In some embodiments, an operation method for a granular material spreading performance detection system for an agricultural unmanned aerial vehicle enables complete detection of the operational performance of an agricultural unmanned aerial vehicle in granular material spreading such as fertilization, seeding, and feed spreading. The method specifically includes steps 1-7.

In step 1, unmanned aerial vehicle mounting and debugging include that: at first, an unmanned aerial vehicle to be tested is fixed to a fixing apparatus of an unmanned aerial vehicle motion control module to avoid data deviation caused by vibration or external force during the test. After the unmanned aerial vehicle is mounted, the unmanned aerial vehicle is debugged by the control platform, and operating states of an airframe and a spreading apparatus are inspected to ensure stability and accuracy of the spreading operation at different heights and angles.

In step 2, sampling platform arrangement and configuration include that: according to a test demand, an appropriate number of sampling unmanned vehicles are arranged in a test area, and a sampling trajectory network and a path of each sampling unmanned vehicle are planned through the control platform to ensure full coverage of a fertilization area; sensors on the sampling unmanned vehicles are calibrated by the sampling platform to achieve accurate measurement of granular material particle mass and spreading uniformity; data collected by the sampling unmanned vehicles are transmitted to a background detection and analysis system in real time to provide support for subsequent data processing.

In step 3, operation height and angle adjustment includes that: before the spreading operation is started, the control platform adjusts a flight height and an attitude angle of the unmanned aerial vehicle through the unmanned aerial vehicle motion control module to simulate spreading effect under different operating conditions; during the test, the control platform can automatically adjust flight parameters of the unmanned aerial vehicle according to real-time meteorological data (such as wind speed, and humidity) to evaluate the influence of environmental factors on the spreading effect, thereby providing data support for spreading optimization under different conditions.

In step 4, fertilization parameter detection includes that: after the unmanned aerial vehicle starts to operate, the multiple sampling unmanned vehicles move according to a specified trajectory to monitor granular material spreading amount at each sampling point in real time; the sensors on the sampling unmanned vehicles transmit the collected data (including particle distribution, spreading amount, spreading speed, and the like) to the control platform in real time to generate an intermediate report, thereby evaluating the spreading effect under different flight parameters and environmental conditions; a spreading path and parameters can be dynamically adjusted according to the data to ensure precise spreading.

In step 5, data analysis and report generation include that: after the test is completed, the control platform comprehensively analyzes the collected spreading data, meteorological and environmental data, and relevant parameters, and generates a detailed analysis report; the analysis report includes spreading uniformity, operation efficiency, the influence of environmental factors on the spreading effect, and the like, thereby providing a scientific basis for the comprehensive evaluation of the spreading operation performance of the unmanned aerial vehicle, and supporting parameter optimization in precision agricultural operations.

In step 6, test site cleaning includes that: after the analysis report is generated, a granular material cleaning and recovery module is activated, a telescopic rod of the granular material cleaning and recovery module extends to an edge of the test area, an elastic brush deploys, concentrates, and cleans the scattered granular materials through circular motion, and then pushes the particles to a designated recovery area to ensure that the site is clean, facilitating smooth progress of a next test.

In step 7, granular material and unmanned aerial vehicle recovery includes that: after cleaning is completed, the granular material cleaning and recovery module is reset to treat the granular material particles in the recovery area in a centralized manner, and the unmanned aerial vehicle motion control module is controlled to land to recover the unmanned aerial vehicle to be tested.

In some embodiments, the control platform collects in real time, analyzes, and displays the granular material spreading performance parameters according to the operations of detection process control, dynamic wind field modeling, and particle trajectory calculation, which includes steps (1)-(7).

In step (1), dynamic wind field modeling includes that: a dynamic wind field model in an operation area is established according to parameters of a wind speed, a wind direction, humidity, and a temperature collected by an environment monitoring module of the granular material spreading performance detection system for an agricultural unmanned aerial vehicle, thereby simulating wind field variations in different heights and areas.

In step (2), particle motion parameter obtaining includes that: parameters such as initial velocity, a release height, and a spreading angle of particles are obtained by a granular material spreading performance detection module of the granular material spreading performance detection system for an agricultural unmanned aerial vehicle to provide a basic input for particle trajectory prediction, and air resistance of spread particles when moving in the air is calculated, where a magnitude of the air resistance is related to particle shape, velocity, and air density.

In step (3), particle trajectory prediction includes that: a motion trajectory and theoretical landing positions of the particles under a wind-free condition are predicted according to the initial velocity, spreading angle, and release height of the particles.

In step (4), wind field interference correction includes that: a theoretical trajectory of the spread particles is corrected based on the wind speed and wind direction data provided by the dynamic wind field model, thereby reflecting actual interference of the wind field on the landing points of the particles, where a magnitude of the wind speed, a wind direction angle, and particle flight time are comprehensively considered during correction.

In step (5), spread particle landing point prediction includes that: an actual landing point of the particles in the operation area is predicted by combining the theoretical trajectory and a wind field interference correction result.

In step (6), spreading uniformity and coverage rate calculation includes that: the spreading uniformity is represented by a ratio of a standard deviation of particle density to a mean value of the particle density, which is used to reflect distribution uniformity of the spread particles, and a spreading coverage rate is determined from a ratio of a particle coverage area to the operation area, which is used to evaluate coverage integrity of a spreading operation.

In step (7), prediction result calibration and analysis report generation include that: a prediction model is calibrated and related parameters are corrected by comparing the predicted landing positions with measured data provided by the sampling platform, and a spreading performance detection report is generated, where the report includes the spreading uniformity, the coverage rate, and wind field interference impact information.

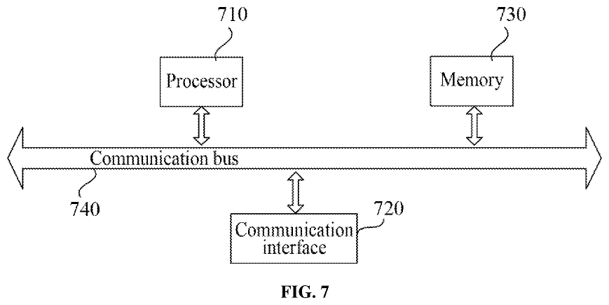

FIG. 7 is a diagram of a structure of an electronic device according to the present disclosure. As shown in FIG. 7, the electronic device may include: a processor 710, a communications interface 720, a memory 730, and a communication bus 740. The processor 710, the communication interface 720, and the memory 730 communicate with each other via the communication bus 740. The processor 710 may invoke a logic instruction in the memory 730 to execute an operation method of a granular material spreading performance detection system for an agricultural unmanned aerial vehicle. The method includes: detecting, by a sampling platform, granular material spreading performance of an unmanned aerial vehicle according to motion and attitude of an unmanned aerial vehicle to obtain granular material spreading performance parameters, where the granular material spreading performance parameters include particle distribution uniformity, a particle on-target impact force, a particle slot entry angle, particle mass, and micro-environment characteristic parameters of spread granular material; collecting in real time, analyzing, and displaying, by a control platform, the granular material spreading performance parameters based on operations of detection process control, dynamic wind field modeling, and particle trajectory calculation, and generating a chart and an analysis report for evaluating spreading performance of the agricultural unmanned aerial vehicle. The control platform can further adjust positions and density of sampling points through a sampling layout adaptive optimization mechanism and an environmental factor quantitative modeling mechanism.

In addition, the logic instruction in the memory 730 may be stored in one computer-readable storage medium when implemented in the form of a software functional unit and sold or used as an independent product. Based on this understanding, the essence of the above technical solution or the part of the technical solution that has contributed to the prior art can be embodied in the form of a software product, the computer software product can be stored in one storage medium, and includes multiple instructions that enable a computer device (which may be a personal computer, a server, a network device, or the like) to execute all or some steps of the methods of various embodiments of the invention. The foregoing storage media include a U disk, a mobile hard disk drive, a read-only memory (ROM), a random access memory (RAM), a magnetic disk, an optical disk, or other media that can store program codes.

In another aspect, the present disclosure further provides a computer program product, where the computer program product includes a computer program, and the computer program is stored on a non-transitory computer-readable storage medium, and when the computer program is executed by the processor, the computer can execute an operation method of a granular material spreading performance detection system for an agricultural unmanned aerial vehicle provided by the foregoing methods. The method includes: detecting, by a sampling platform, granular material spreading performance of an unmanned aerial vehicle according to motion and attitude of an unmanned aerial vehicle to obtain granular material spreading performance parameters, where the granular material spreading performance parameters include particle distribution uniformity, a particle on-target impact force, a particle slot entry angle, particle mass, and micro-environment characteristic parameters of spread granular material; collecting in real time, analyzing, and displaying, by a control platform, the granular material spreading performance parameters based on operations of detection process control, dynamic wind field modeling and particle trajectory calculation, and generating a chart and an analysis report for evaluating spreading performance of the agricultural unmanned aerial vehicle. The control platform can further adjust positions and density of sampling points through a sampling layout adaptive optimization mechanism and an environmental factor quantitative modeling mechanism.

The apparatus embodiments described above are merely illustrative. Units described as separate components may or may not be physically separate, and components displayed as units may or may not be physical units, which may be located in one place, or may be distributed on multiple network units. Some or all of the units may be selected according to actual requirements to implement the objectives of the solutions in this embodiment. Those of ordinary skill in the art may appreciate and implement the present disclosure without creative efforts.

From the description of the foregoing embodiments, those skilled in the art may clearly understand that each embodiment can be implemented by means of software and necessary general hardware platform, and certainly, it may also be implemented by means of hardware. Based on this understanding, the essence of the above technical solution or the part of the technical solution that has contributed to the prior art can be embodied in the form of a software product, the computer software product can be stored in a computer-readable storage medium, such as ROM/RAM, a magnetic disk, an optical disk, and the like, and includes multiple instructions that enable a computer device (which may be a personal computer, a server, a network device, or the like) to execute all or some steps of the methods of various embodiments.

Finally, it should be noted that the foregoing embodiments are merely used to describe the technical solutions of the present disclosure, rather than limitation. Although the present disclosure is described in detail with reference to the foregoing embodiments, a person of ordinary skill in the art should understand that: the technical solutions described in the foregoing embodiments may still be modified, or some technical features thereof may be equivalently replaced. These modifications or replacements shall not cause the essential nature of the corresponding technical solution to deviate from the spirit and scope of the technical solutions in the embodiments of the present disclosure.

1-10. (canceled)

11. A material spreading performance detection system for an agricultural unmanned aerial vehicle, comprising:
an unmanned aerial vehicle platform, configured to control motion and attitude of an unmanned aerial vehicle, wherein the attitude comprises a flight height, a heading angle, a pitch angle, and a roll angle;
a sampling platform, configured to detect material spreading performance of the unmanned aerial vehicle according to the motion and attitude of the unmanned aerial vehicle to obtain material spreading performance parameters, wherein the material spreading performance parameters comprise particle distribution uniformity, a particle on-target impact force, a particle slot entry angle, particle mass, and micro-environment characteristic parameters of spread materials; and
a control platform, wherein the control platform is configured to control collaborative operation of the unmanned aerial vehicle platform and the sampling platform, the control platform is configured to collect in real time, analyze, and display the material spreading performance parameters based on operations of detection process control, dynamic wind field modeling and particle trajectory calculation, and generate a chart and an analysis report for evaluating spreading performance of the agricultural unmanned aerial vehicle;
the control platform comprises:
an analysis module, configured to calculate material spreading performance indicators of the unmanned aerial vehicle according to collected material spreading performance parameters and environmental meteorological data, and generate the chart and the analysis report, wherein the material spreading performance indicators comprise spreading uniformity, material distribution, and a coverage rate;
the analysis module comprises a dynamic wind field model and a particle trajectory calculation model, and is configured to perform fusion analysis on environment parameters and the material spreading performance parameters, wherein the dynamic wind field model is configured to construct a meteorological scene in an operation area in real time through wind speed, wind direction, humidity, and temperature data, and the particle trajectory calculation model is configured to calculate and predict landing positions of spread particles based on the dynamic wind field model, thereby evaluating influence of wind field interference on particle distribution; and
the control platform is capable of further adjusting positions and density of sampling points through a sampling layout adaptive optimization mechanism and an environmental factor quantitative modeling mechanism.

12. The material spreading performance detection system for the agricultural unmanned aerial vehicle according to claim 11, wherein the unmanned aerial vehicle platform comprises:
an unmanned aerial vehicle motion control module, mounted at a middle area of the unmanned aerial vehicle platform, wherein the unmanned aerial vehicle motion control module is configured to control motion and attitude states of the unmanned aerial vehicle; and
a material cleaning and recovery module, mounted at a bottom of the unmanned aerial vehicle platform, wherein the material cleaning and recovery module is configured to control a telescopic rod and a brush to recover materials spread on ground according to a cleaning instruction, wherein the cleaning instruction, based on the control platform, obtains a size of a test area, a spreading coverage range, and distribution information of remaining materials, thereby achieving recovery of all spread materials in the test area.

13. The material spreading performance detection system for the agricultural unmanned aerial vehicle according to claim 11, wherein the sampling platform comprises:
a plurality of sampling unmanned vehicles, wherein each sampling unmanned vehicle has Global Navigation Satellite System (GNSS) positioning and LiDAR-assisted perception functions, and collects the material spreading performance parameters according to a navigation route;
a networking collaboration module, wherein the plurality of sampling unmanned vehicles are in communication connection with the networking collaboration module separately, and the networking collaboration module is configured to achieve collaborative operation and path obstacle avoidance among the plurality of sampling unmanned vehicles by sharing real-time position data and sampling state information of each sampling unmanned vehicle;
a sampling track network, wherein the sampling track network supports circular, square, and custom-shaped layouts, and is arranged around the sampling platform according to any one of following sampling layout setting principles:
the sampling points are equidistantly distributed along a radial direction with the unmanned aerial vehicle platform as a center to form an annular or radial track, wherein a radius of the annular track and a number of the sampling points are determined according to a spreading width of the unmanned aerial vehicle and particle distribution variability;
the sampling points are arranged in a uniform grid pattern in a regular plot, and horizontal and vertical spacings are set according to the spreading width and a size of the operation area;
for an irregular plot or a complex terrain, a sampling track is flexibly arranged according to a farmland shape, a topographical variation, and crop growth characteristics; and
wherein meteorological parameters of a wind speed, a wind direction, the humidity, and a temperature are monitored in real time during sampling operation, and the density of the sampling points is dynamically adjusted in combination with spreading uniformity data; and
an environment monitoring module, configured to collect meteorological parameters in the operation area of the unmanned aerial vehicle, and detect a spreading trajectory in real time through collaboration of the dynamic wind field model and the particle trajectory calculation model to evaluate influence of the meteorological parameters on the particle distribution, wherein the meteorological parameters comprise a wind speed, a wind direction, the humidity, a temperature, and an atmospheric pressure.

14. The material spreading performance detection system for the agricultural unmanned aerial vehicle according to claim 13, wherein each sampling unmanned vehicle comprises:
a chassis, wherein the chassis comprises a power system, a navigation system, a suspension structure, and a absorber structure;
a material particle collection apparatus, wherein a chute of the material particle collection apparatus employs a double-layer structure, and a top layer of the double-layer structure is a reversible V-shaped guide plate;
a material spreading performance detection module, comprising an optical sensor, a piezoelectric sensor, and an angle sensor, wherein the material spreading performance detection module is configured to collect the particle distribution uniformity, the particle mass, and spreading amount; and
a material recovery apparatus, mounted at a bottom of the sampling unmanned vehicle, wherein the material recovery apparatus is configured to store a material particle sample and has automatic weighing and spectral analysis functions.

15. The material spreading performance detection system for the agricultural unmanned aerial vehicle according to claim 11, wherein the control platform comprises:
a detection process control module, configured to set and adjust and control in real time various parameters during entire test process;
an analysis module, configured to calculate material spreading performance indicators of the unmanned aerial vehicle according to collected material spreading performance parameters and environmental meteorological data, and generate the chart and the analysis report, wherein the material spreading performance indicators comprise spreading uniformity, material distribution, and a coverage rate; and
a visualization module, wherein the visualization module is configured to display the material spreading performance parameters, the chart, and the analysis report, and supports real-time monitoring and historical data backtracking.

16. An operation method of a material spreading performance detection system for an agricultural unmanned aerial vehicle, wherein the method is applied to the material spreading performance detection system for the agricultural unmanned aerial vehicle according to claim 11, and comprises:
detecting, by the sampling platform, the material spreading performance of the unmanned aerial vehicle according to the motion and attitude of the unmanned aerial vehicle to obtain the material spreading performance parameters, wherein the material spreading performance parameters comprise the particle distribution uniformity, the particle on-target impact force, the particle slot entry angle, the particle mass, and the micro-environment characteristic parameters of the spread materials; and
collecting in real time, analyzing, and displaying, by the control platform, the material spreading performance parameters based on the operations of detection process control, dynamic wind field modeling, and particle trajectory calculation, and generating the chart and the analysis report for evaluating spreading performance of the agricultural unmanned aerial vehicle, wherein
the control platform is capable of further adjusting the positions and the density of sampling points through the sampling layout adaptive optimization mechanism and the environmental factor quantitative modeling mechanism.

17. The operation method of the material spreading performance detection system for the agricultural unmanned aerial vehicle according to claim 16, wherein after generating the chart and the analysis report, the method further comprises:
calculating a material spreading coefficient of variation and a material spreading root mean square error according to the material spreading performance parameters, and calculating a material spreading operation evaluation result of the unmanned aerial vehicle by using following formula:
$$F = {W}_{1} C V + {W}_{2} RMSE ;$$
wherein F is the material spreading operation evaluation result of the unmanned aerial vehicle, CV is the material spreading coefficient of variation, and RAISE is the material spreading root mean square error; W₁ and W₂ are weight coefficients, wherein a value of each weight coefficient ranges from 0 to 1, and W₁+W₂=1; a value of F ranges from 0 to 1, wherein 1 denotes a best fertilization effect, and 0 represents a worst fertilization effect.

18. The operation method of the material spreading performance detection system for the agricultural unmanned aerial vehicle according to claim 16, wherein the collecting in real time, analyzing, and displaying, by the control platform, the material spreading performance parameters based on the operations of detection process control, dynamic wind field modeling, and particle trajectory calculation comprises:
establishing the dynamic wind field model in the operation area according to parameters of the wind speed, the wind direction, the humidity, and a temperature collected by an environment monitoring module of the material spreading performance detection system for the agricultural unmanned aerial vehicle, thereby simulating wind field variations in different heights and areas;
obtaining parameters of initial velocity, a release height, and a spreading angle of particles by a material spreading performance detection module of the material spreading performance detection system for the agricultural unmanned aerial vehicle to provide a basic input for particle trajectory prediction, and calculating air resistance of spread particles when moving in the air, wherein a magnitude of the air resistance is related to particle shape, velocity, and air density;
predicting motion trajectories and theoretical landing positions of the particles under a wind-free condition according to the initial velocity, the spreading angle, and the release height of the particles;
correcting theoretical trajectories of the spread particles based on data of the wind speed and the wind direction provided by the dynamic wind field model, thereby reflecting actual interference of the wind field on the landing positions of the particles, wherein a magnitude of the wind speed, a wind direction angle, and particle flight time are comprehensively considered during correction;
predicting actual landing positions of the particles in the operation area by combining the theoretical trajectories and a wind field interference correction result;
representing spreading uniformity by a ratio of a standard deviation of particle density to a mean value of the particle density, which is used to reflect distribution uniformity of the spread particles, and determining a spreading coverage rate from a ratio of a particle coverage area to the operation area, which is used to evaluate coverage integrity of a spreading operation; and
calibrating a prediction model and correcting related parameters by comparing predicted landing positions with measured data provided by the sampling platform, and generating a spreading performance detection report, wherein the report comprises the spreading uniformity, the coverage rate, and wind field interference impact information.

19. An electronic device, comprising: a memory, a processor, and a computer program that is stored in the memory and that is run on the processor, wherein when the processor executes the computer program, the operation method of the material spreading performance detection system for the agricultural unmanned aerial vehicle according to claim 16 is implemented.

20. The electronic device according to claim 19, wherein the processor executes the computer program for: after generating the chart and the analysis report,
calculating a material spreading coefficient of variation and a material spreading root mean square error according to the material spreading performance parameters, and calculating a material spreading operation evaluation result of the unmanned aerial vehicle by using following formula:
$$F = {W}_{1} C V + {W}_{2} RMSE ;$$
wherein F is the material spreading operation evaluation result of the unmanned aerial vehicle, CV is the material spreading coefficient of variation, and RAISE is the material spreading root mean square error; W₁ and W₂ are weight coefficients, wherein a value of each weight coefficient ranges from 0 to 1, and W₁+W₂=1; a value of F ranges from 0 to 1, wherein 1 denotes a best fertilization effect, and 0 represents a worst fertilization effect.

21. The electronic device according to claim 19, wherein the collecting in real time, analyzing, and displaying, by the control platform, the material spreading performance parameters based on the operations of detection process control, dynamic wind field modeling, and particle trajectory calculation comprises:
establishing the dynamic wind field model in the operation area according to parameters of the wind speed, the wind direction, the humidity, and a temperature collected by an environment monitoring module of the material spreading performance detection system for the agricultural unmanned aerial vehicle, thereby simulating wind field variations in different heights and areas;
obtaining parameters of initial velocity, a release height, and a spreading angle of particles by a material spreading performance detection module of the material spreading performance detection system for the agricultural unmanned aerial vehicle to provide a basic input for particle trajectory prediction, and calculating air resistance of spread particles when moving in the air, wherein a magnitude of the air resistance is related to particle shape, velocity, and air density;
predicting motion trajectories and theoretical landing positions of the particles under a wind-free condition according to the initial velocity, the spreading angle, and the release height of the particles;
correcting theoretical trajectories of the spread particles based on data of the wind speed and the wind direction provided by the dynamic wind field model, thereby reflecting actual interference of the wind field on the landing positions of the particles, wherein a magnitude of the wind speed, a wind direction angle, and particle flight time are comprehensively considered during correction;
predicting actual landing positions of the particles in the operation area by combining the theoretical trajectories and a wind field interference correction result;
representing spreading uniformity by a ratio of a standard deviation of particle density to a mean value of the particle density, which is used to reflect distribution uniformity of the spread particles, and determining a spreading coverage rate from a ratio of a particle coverage area to the operation area, which is used to evaluate coverage integrity of a spreading operation; and
calibrating a prediction model and correcting related parameters by comparing predicted landing positions with measured data provided by the sampling platform, and generating a spreading performance detection report, wherein the report comprises the spreading uniformity, the coverage rate, and wind field interference impact information.

22. A non-transitory computer-readable storage medium, wherein a computer program is stored on the non-transitory computer-readable storage medium, and when the computer program is executed by the processor, the operation method of the material spreading performance detection system for the agricultural unmanned aerial vehicle according to claim 16 is implemented.

23. The non-transitory computer-readable storage medium according to claim 22, wherein the computer program is executed for: after generating the chart and the analysis report,
calculating a material spreading coefficient of variation and a material spreading root mean square error according to the material spreading performance parameters, and calculating a material spreading operation evaluation result of the unmanned aerial vehicle by using following formula:
$$F = {W}_{1} C V + {W}_{2} RMSE ;$$
wherein F is the material spreading operation evaluation result of the unmanned aerial vehicle, CV is the material spreading coefficient of variation, and RAISE is the material spreading root mean square error; W₁ and W₂ are weight coefficients, wherein a value of each weight coefficient ranges from 0 to 1, and W₁+W₂=1; a value of F ranges from 0 to 1, wherein 1 denotes a best fertilization effect, and 0 represents a worst fertilization effect.

24. The non-transitory computer-readable storage medium according to claim 22, wherein the collecting in real time, analyzing, and displaying, by the control platform, the material spreading performance parameters based on the operations of detection process control, dynamic wind field modeling, and particle trajectory calculation comprises:
establishing the dynamic wind field model in the operation area according to parameters of the wind speed, the wind direction, the humidity, and a temperature collected by an environment monitoring module of the material spreading performance detection system for the agricultural unmanned aerial vehicle, thereby simulating wind field variations in different heights and areas;
obtaining parameters of initial velocity, a release height, and a spreading angle of particles by a material spreading performance detection module of the material spreading performance detection system for the agricultural unmanned aerial vehicle to provide a basic input for particle trajectory prediction, and calculating air resistance of spread particles when moving in the air, wherein a magnitude of the air resistance is related to particle shape, velocity, and air density;
predicting motion trajectories and theoretical landing positions of the particles under a wind-free condition according to the initial velocity, the spreading angle, and the release height of the particles;
correcting theoretical trajectories of the spread particles based on data of the wind speed and the wind direction provided by the dynamic wind field model, thereby reflecting actual interference of the wind field on the landing positions of the particles, wherein a magnitude of the wind speed, a wind direction angle, and particle flight time are comprehensively considered during correction;
predicting actual landing positions of the particles in the operation area by combining the theoretical trajectories and a wind field interference correction result;
representing spreading uniformity by a ratio of a standard deviation of particle density to a mean value of the particle density, which is used to reflect distribution uniformity of the spread particles, and determining a spreading coverage rate from a ratio of a particle coverage area to the operation area, which is used to evaluate coverage integrity of a spreading operation; and
calibrating a prediction model and correcting related parameters by comparing predicted landing positions with measured data provided by the sampling platform, and generating a spreading performance detection report, wherein the report comprises the spreading uniformity, the coverage rate, and wind field interference impact information.
